(19) United States
(12) Patent Application Publication
(10) Pub. No.: US 2008/0032686 A1
(43) Pub. Date: Feb. 7, 2008

(54) Method and device for making awareness of occurence of a supplementary service

(75) Inventors: Jie Xu, Guangdong Province (CN); Dongming Zhu, Guangdong Province (CN)

Correspondence Address: Ladas & Parry LLP, 26 West 61 Street, New York, NY, 10023, US

(73) Assignee: HUAWEI TECHNOLOGIES CO., LTD.

(21) Appl. No.: 11/881,806

(22) Filed: Jul. 27, 2007

Related U.S. Application Data
(63) Continuation of application No. PCT/CN07/00435, filed on Feb. 8, 2007.

(30) Foreign Application Priority Data
Feb. 8, 2007 (CN) CN20076/000435
Apr. 29, 2006 (CN) CN200610079107.5
Jul. 28, 2006 (CN) CN200610099533.5

(51) Int. Cl. H04Q 7/20

(52) U.S. Cl. 455/422.1

(57) ABSTRACT

A method for making awareness of occurrence of a supplementary service, a Voice Call Continuity service control entity and a media gateway control entity are disclosed. With the method, a Voice Call Continuity service control entity and/or a user may make awareness of the occurrence of a supplementary service in an IMS-based network architecture. The method includes: obtaining a notification signaling notifying that a user performs a supplementary service by at least one of the Voice Call Continuity service control entity or an opposite end of a call, and making awareness of occurrence of the supplementary service according to the notification signaling. With the method, functions of the Voice Call Continuity service control entity may be improved, so that the Voice Call Continuity service control entity may receive notification signaling notifying that a user performs a supplementary service, and to resolve the notification signaling, and to update the call attribute of the user.

This application claims the priorities of Chinese Patent Application No. 200610079107.5 filed on Apr. 29, 2006, titled “METHOD AND DEVICE FOR MAKING AWARENESS OF OCCURRENCE OF A SUPPLEMENTARY SERVICE OF A USER”, and Chinese Patent Application No. 200610099533.5 filed on Jul. 28, 2006, titled “METHOD AND DEVICE FOR MAKING AWARENESS OF OCCURRENCE OF A SUPPLEMENTARY SERVICE OF A USER”, which are incorporated herein by reference in entirety.

### FIELD OF THE INVENTION

The present invention relates to the field of wireless communications, in particular, to a method and a device for making awareness of occurrence of a supplementary service.

### BACKGROUND OF THE INVENTION

While wireless network evolves from 2G network to 3G network, the 2G network will coexist with the 3G network for a very long time. In view of such a case, the interoperability between the 2G network and the 3G network are drawing people's attention.

Network side has to make awareness of the registration state of a user on the two networks, so that an appropriate network may be selected for routing when a call is to be connected to the user. In addition, the network side has to anchor all the calls of a user, so as to perform auxiliary control when the user is handed off between the two networks.

To meet the above mentioned requirements of the network side, both of Third Generation Partnership Projects (3GPP) and 3GPP2 have constituted a network architecture including an Internet Protocol Multimedia Subsystem (IMS)-based network entity. The IMS-based network entity is designed for anchoring control, and for detecting the registration and session state of a user on the two networks, and controlling the routing and handover of a call of the user based on the registration and session state of the user. FIG. 1 shows the network architecture constituted by 3GPP2.

As shown in FIG. 2, each Call Server Control Function (CSCF) and a Home Subscriber Server (HSS) are IMS-domain devices, a Home Location Register (HLR) and a Mobile Services switching Center/Visited Location Register (MSC/VLR) are Circuit Switched-domain (CS-domain) devices, and a Media Gateway Control Function (MGCF) is a gateway for connection between the CS domain and the IMS domain. In this network architecture, a network element, i.e., Voice Call Continuity Application Server (VCC) service control entity, is added between the IMS domain and the CS domain. The VCC service control entity has interfaces at both of the two domains. The VCC service control entity may have the following functions of:

1. serving as an Application Server (AS) in the IMS domain, using a standard IMS service control (ISC) interface in communication with an Inquiring Call Session Control Function (I-CSCF) or a Serving Call Session Control Function (S-CSCF), and using a standard Sh interface in communication with the HSS;

2. using a standard Mobile Application Part (MAP) interface to the CS-domain entity HLR, where the VCC service control entity is a Gateway Mobile Switch Center (GMSC) in the view of the HLR;

3. recording the registration state and the call state of a user on the two networks;

4. anchoring in the call path of a user;

5. making route decision according to the registration state and the call state of the user in a called process;

6. controlling a call during a hand off across the networks.

At present, various supplementary services may be implemented in the CS domain. An example is Explicit Call Transfer (ECT) service, also referred to as Call Transfer (CT) service. The process of the call transfer service is as follows: when a user A who has subscribed the ECT service are in conversation with a user B, the user A may first arrange the user B in a call hold state and then call a user C. The user A may release the call when the user C is alerted or after the user C is connected. At this time, the network will connect the user B with the user C so that the conversation is continued between the user B and the user C, while the user A may quit the call and become idle. The different occasions for the user A to release the call will be described below:

I. The user A releases the call after the user C is connected.

At this time, the user A has established a call with each of the user B and the user C, while the call between the user A and the user B is held temporarily. The subsequent process may be as follows as shown in FIG. 2:

1. The user A sends a RELEASE (call release) message to an MSC A, and initiates a request for invoking the ECT service.

2. The MSC A initiates a CPG (Call Progress) notification to the user B for retrieving the call.

3. The MSC A sends a RELEASE COMPLETE (call release complete) message to the user A, releases the call with the user A, and connects the user B with the user C.

4. If the user A has subscribed an ECT notification service, the MSC A has to send a notification message to the user B notifying the user B of the ECT service and the number of the user C. The notification message is usually a CPG (Call Progress) message including a parameter, i.e., Generic notification indicators, for indicating that an ECT service has occurred and that whether the user C is in an alerted state or an answering state. This message further includes a parameter, i.e., Call transfer number, for carrying the number of the user C.

5. Similarly, the MSC A also sends a notification message to the user C.

Finally, the MSC A, to which the user A pertains, will establish a call between the user B and the user C.

II. The user A releases the call when the user C is alerted.

At this time, the user A has established a call with each of the user B and the user C, while the call between the user A and the user B is held temporarily. As shown in FIG. 3, the subsequent process is similar with the above process in which an ECT service is invoked after the user C is connected, with a difference in that the user B is indicated of the alerted state and a ring back tone is played to the user B (step 3), and the user B will get a notification about connection after the user C is connected (step 6), thus the ECT service is completed.

According to the above network architecture (containing a VCC service control entity) and the process for implementing the ECT service, the routing state of network before the ECT service is performed (that is, when the user A establishes a call with the user B and the user C respectively) may be as shown in FIG. 4. The user A is connected, on both of the signaling plane and the bearer plane, with the user B and the user C respectively, while the VCC service control entity anchors in two call signaling paths (i.e., the call signaling path between the user A and the user B, and the call signaling path between user A and user C) respectively, and records the registration states and the call states of the users A, B and C in the two networks.

FIG. 5 shows the network routing state after the ECT service is completed (i.e., the user A becomes idle, and a call is established between the user B and the user C). The connections on the signaling plane and the bearer plane between the user B and the user C are still controlled and connected by the original MSC, while the VCC service control entity still anchors in the call signaling path including the user A, and gets no notification. At the same time, no change occurs in the call state of the user A recorded by the VCC service control entity. Moreover, the user B and the user C will not receive a notification that user A has performed the ECT service.

Therefore, if a user subscribes a forwarding service and a forwarding process is triggered at a GMSC, the GMSC cannot notify the forwarding event to the VCC service control entity and the calling user. In addition, the VCC service control entity cannot correctly make awareness of the call state of user, and the calling user cannot make awareness of that the call is forwarded.

Thus, a VCC service control entity cannot make awareness of the occurrence of a supplementary service at the user side after a supplementary service is initiated by an IMS domain user, the call of which is anchored by the VCC service control entity. Even if the VCC service control entity may receive a notification message about the supplementary service, the VCC service control entity cannot update the call state and session handover capability of the user, based on the functions of the VCC service control entity presently defined. As a result, the call state and session handover capability of the user recorded in the VCC service control entity remains unchanged even if the call state of the user has changed. Subsequently, when a new call needs to be connected to the user, or when the session in which the user participates is handed over, the VCC service control entity may make a wrong decision according to the wrong information. Accordingly, the user may get a bad experience. In addition, after an IMS domain user, the call of which is anchored by the VCC service control entity, initiates a supplementary service, the two new parties of the call can not be informed of the supplementary service in the related art.

### SUMMARY OF THE INVENTION

Embodiments of the invention provide a method for making awareness of occurrence of a supplementary service, a VCC service control entity and a media gateway control entity, so as to solve the problem that the VCC service control entity is not able to make awareness of the change in the calling attribute of the user and update the record after a supplementary service is initiated by an IMS domain user, the call of which is anchored by the VCC service control entity, and the problem that the other side can not be notified about the occurrence of a supplementary service after the supplementary service is initiated by the IMS domain user, the call of which is anchored by the VCC service control entity.

In a method for making awareness of occurrence of a supplementary service initiated by a user according to an embodiment of the invention, a VCC service control entity and/or a user is enabled to make awareness of occurrence of the supplementary service in a network architecture containing an Internet Protocol Multimedia System-based entity for anchoring control. The method may include: obtaining a notification signaling notifying occurrence of a supplementary service of a user by at least one of a Voice Call Continuity service control entity or an opposite end of a call; and making awareness of occurrence of the supplementary service according to the notification signaling.

A VCC service control entity according to an embodiment of the invention includes: an awareness unit for identifying a notification signaling notifying occurrence of a supplementary service of a user from signaling received by the Voice Call Continuity service control entity; and a resolving unit for resolving supplementary service notification content obtained from the notification signaling identified by the awareness unit and thereby triggering the recording unit to update the call attribute of the user.

A media gateway control entity according to an embodiment of the invention includes: an obtaining unit, for obtaining supplementary service notification content from a received trunk signaling; and a converting unit, for converting the supplementary service notification content obtained by the obtaining unit into a notification signaling of Session Initiation Protocol format notifying occurrence of a supplementary service of a user, and sending the notification signaling of Session Initiation Protocol format to at least one of a user side or a Voice Call Continuity service control entity.

Optionally, the obtaining unit obtains at least one of a service type indicator or a connected user identifier from the trunk signaling.

In the method for making awareness of occurrence of a supplementary service of a user according to the embodiments of the invention, a VCC service control entity may be able to make awareness of the occurrence of a supplementary service, so that the calling attribute of the user stored in the VCC service control entity may be updated. In addition, the user side may be notified.

### BRIEF DESCRIPTION OF THE DRAWINGS

FIG. 1 is a schematic diagram of a network architecture constituted by 3GPP2;

FIG. 2 is a flow chart showing a process that a user A releases a call after the user A connects the call to a user. C in the existing ECT service;

FIG. 3 is a flow chart showing the process that a user A releases a call when a user C is alerted in the existing ECT service;

FIG. 4 is a schematic diagram of network routing state before a user performs the ECT service in the related art;

FIG. 5 is a schematic diagram of network routing state after the ECT service is completed in the related art;

FIG. 6 is a structural representation of a media gateway control entity according to an embodiment of the invention;

FIG. 7 is a structural representation of a VCC service control entity according to an embodiment of the invention;

FIG. 8 is a flow chart showing a first method according to an embodiment of the invention;

FIG. 9 is a flow chart showing Example 1 of the first method according to the embodiment of the invention;

FIG. 10 is a flow chart showing Example 2 of the first method according to the embodiment of the invention;

FIG. 11 is a flow chart showing Example 3 of the first method according to the embodiment of the invention;

FIG. 12 is a flow chart showing Example 4 of the first method according to the embodiment of the invention; and

FIG. 13 is a flow chart showing a second method according to an embodiment of the invention.

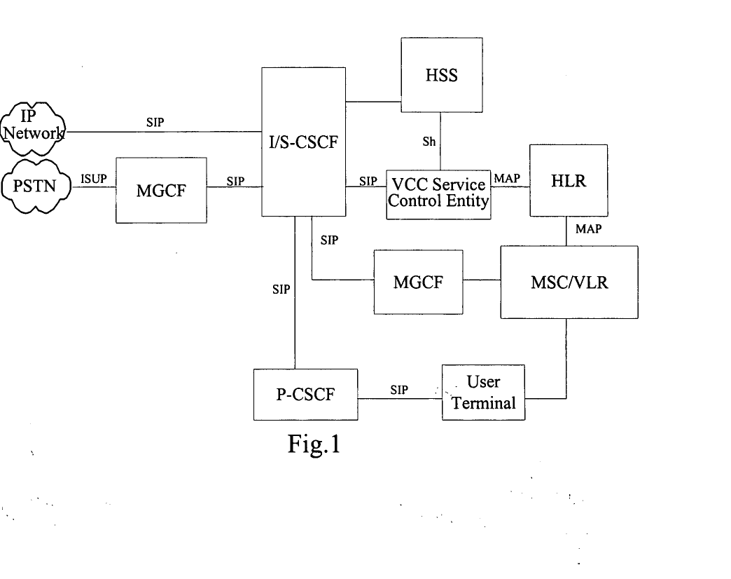

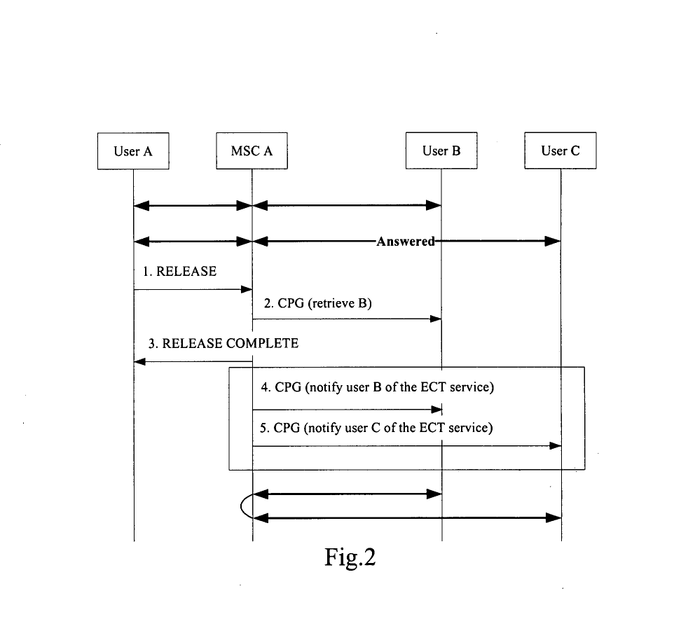

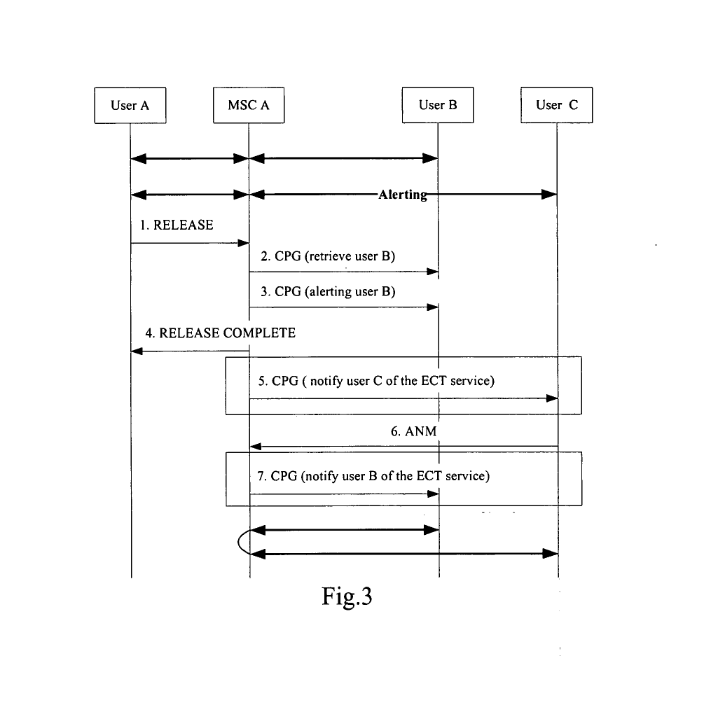

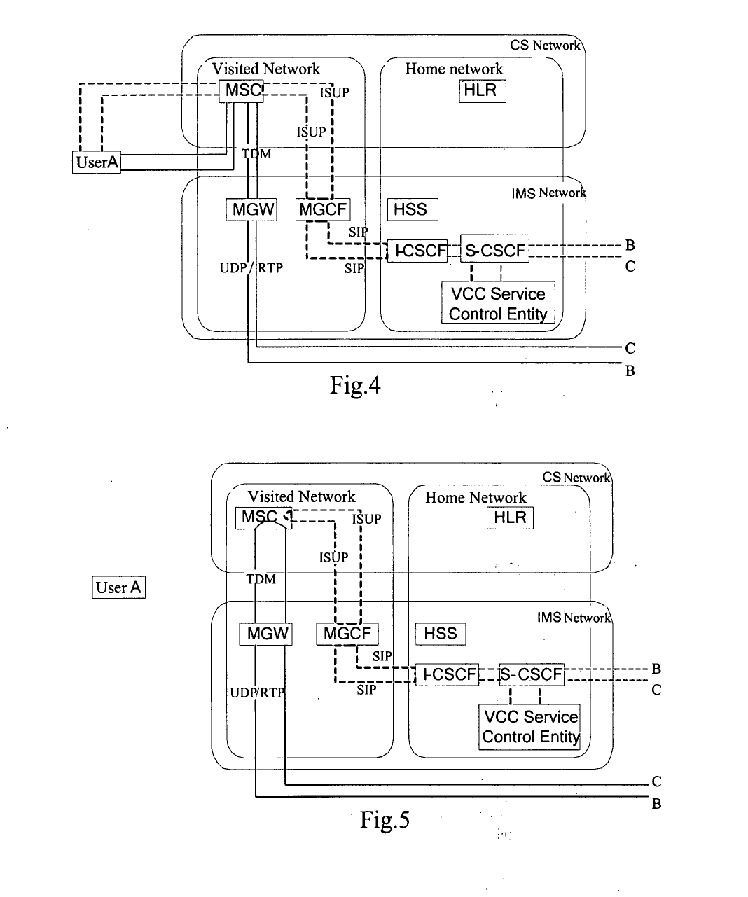

### DETAILED DESCRIPTION OF THE EMBODIMENTS

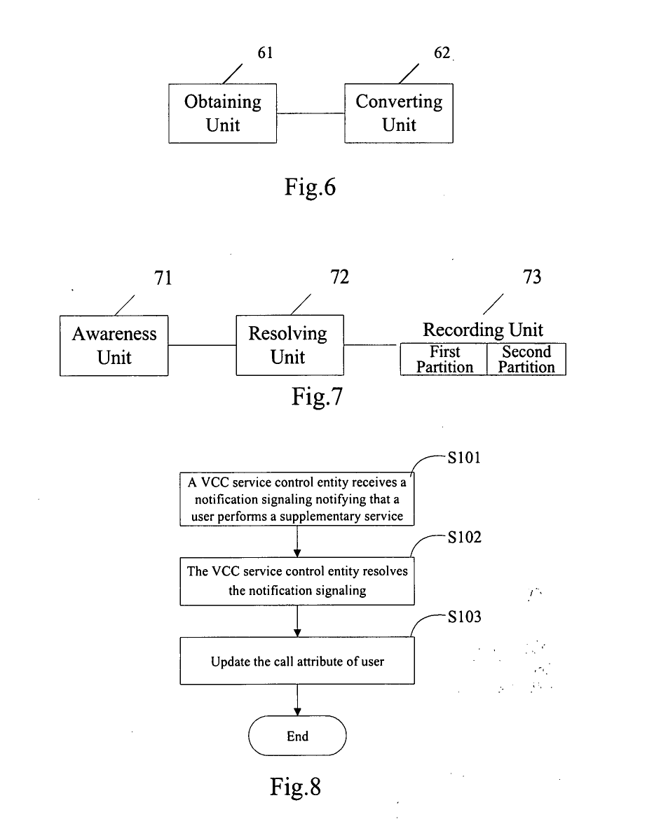

An embodiment of the invention provides a Media Gateway Control Function (MGCF). With the MGCF, a VCC service control entity may make awareness of the change in call attribute (e.g., call state, session handover capability and the like) of a user of IMS domain and thereby update the call attribute of the user recorded in the VCC service control entity after the IMS domain user, the call of which is anchored by the VCC service control entity initiates a supplementary service. Consequently, when a new call needs to be connected to the user or when the session in which the user participates is handed over, the VCC service control entity may make correct routing decision or perform correct handover operation. Further, with the MGCF, the user side may be informed of the supplementary service after the supplementary service is initiated by the IMS domain user, the call of which is anchored by the VCC service control entity. The MGCF is as shown in FIG. 6, which includes an obtaining unit 61 and a converting unit 62 connected with each other.

The obtaining unit 61 is adapted to receive external signaling and obtain supplementary service notification content from a trunk signaling received. From the trunk signaling, this unit may obtain only at least one of a service type indicator or a connected user identifier, as well as other additional information (such as a number of a new opposite end of a call in the ECT service, or a forwarded-to number in a call forwarding service).

The converting unit 62 is adapted to convert the supplementary service notification content obtained by the obtaining unit into a notification signaling in SIP (Session Initiation Protocol) format notifying that a user performs a supplementary service, and send the notification signaling to the user side. Accordingly, the notification signaling includes at least one of a service type indicator or a connected user identifier, and may also include a number of a new opposite end of a call or a call forwarded-to number, etc.

An embodiment of the invention further provides a VCC (Voice Call Continuity) service control entity as shown in FIG. 7, which includes an awareness unit 71, a resolving unit 72 and a recording unit 73 which are concatenated.

The awareness unit 71 is adapted to identify a notification signaling notifying that a user performs a supplementary service from signaling received by the VCC service control entity. The notification signaling includes, but is not limited to, SIP notification signaling (sent from the MGCF according to an embodiment of the invention) and CAP (Customized Application of Mobile Enhanced Logic (CAMEL) Application Part) notification signaling (sent from an MSC).

The resolving unit 72 is adapted to resolve the supplementary service notification content obtained from the notification signaling identified by the awareness unit and thereby trigger the recording unit to update call attribute of the user. This unit utilizes different resolving strategies to resolve different types of notification signaling. The supplementary service notification content resolved includes at least one of a service type indicator or a connected user identifier. Other additional information may also be resolved (such as a number of a new opposite end of a call in an ECT service, or a forwarded-to number in forwarding service).

The recording unit 73 includes at least one of a first partition for recording the session handover capability of a user and a second partition for recording call state of a user. When only the session handover capability needs to be updated, the first partition updates the session handover capability of the user according to at least one of a service type indicator resolved by the resolving unit or the comparison result between the connected user identifier resolved by the resolving unit and the original called number. If the connected user identifier resolved is different from the original called number, the recording unit determines that the call has been forwarded, and updates the session handover capability of the user. When both of the session handover capability and call state need updating, the first partition updates the session handover capability of the user according to at least one of the service type indicator resolved by the resolving unit or the comparison result between the connected user identifier resolved by the resolving unit and the original called number. If the connected user identifier resolved is different from the original called number, the first partition determines that the call has been forwarded, and updates the session handover capability of the user, and triggers the second partition to update the call state recorded in the second partition. When only the call state needs updating, the second partition updates the call state of the user according to the service type indicator resolved by at least one of the resolving unit or the connected user identifier.

If the VCC service control entity is divided into two logic entities including a Call Continuity Control Function (CCCF) for controlling the anchoring and handover of a call and a

Network Domain Selection Function (NeDS) for controlling the selection of network domain, the CCCF may function as the awareness unit, and the functions of the resolving unit and the recording unit may be disassembled in the CCCF and the NeDS. The CCCF is adapted to configure the session handover capability of a user (configure all the sessions related to the user who initiates the supplementary service as non-switch-supporting) according to at least one of the service type indicator or the connected user identifier, and to indicate the NeDS to update the call state of the user (modify the call state of the user initiating the supplementary service to idle state).

By using the above function entities, an embodiment of the invention provides a method for making awareness of occurrence of a supplementary service of a user. This method may be applied in a network architecture in which an IMS-based entity performs anchoring control, so that at least one of a VCC service control entity or a user may make awareness of the occurrence of a supplementary service. In an implementation, at least one of the VCC service control entity or the user obtains a notification signaling notifying that a user performs a supplementary service respectively, and at least one of the VCC service control entity or the user may make awareness of the occurrence of the supplementary service according to the notification signaling.

FIG. 8 shows a flow chart of a method for a VCC service control entity to make awareness of occurrence of a supplementary service of a user according to an embodiment of the invention. The method may include:

In block S101: a VCC service control entity receives a notification signaling notifying that a user performs a supplementary service.

The user initiating a supplementary service can subscribe a supplementary notification service first, or a MSC may send a notification for each of supplementary services. The supplementary services may include, but are not limited to, ECT service, forwarding service, call hold service or call waiting service. Accordingly, the notification signaling may be a call alerting notification, or a forwarding notification, or a call answer notification.

If the supplementary service is an ECT service, a forwarding service, a call hold service or a call waiting service, the MSC (not limited to MSC) sends a trunk signaling containing supplementary service notification content to an MGCF after the user initiates the supplementary service. The MGCF obtains the supplementary service notification content contained in the trunk signaling via an obtaining unit and converts the supplementary service notification content into a notification signaling of SIP format via a converting unit. The supplementary service notification content includes at least a service type indicator or a connected user identifier. The MGCF sends the notification signaling to the VCC service control entity. The VCC service control entity identifies and receives the notification signaling via an awareness unit.

Alternatively, if the supplementary service is an ECT service, a call hold service or a call waiting service, the MSC may report a notification signaling of CAP format (not limited to CAP format) containing the supplementary service notification content (which includes at least the service type indicator or the connected user identifier) directly to the VCC service control entity after the user initiates the supplementary service, according to the subscription information of the user (supplementary service-CAMEL subscriber information, SS-CSI) and the address of the VCC service control entity indicated in the subscription information (SCP (Service Control Point) address is set as the address of the VCC service control entity). The VCC service control entity identifies and receives the notification signaling via an awareness unit.

In block S102: the VCC service control entity resolves the notification signaling.

The VCC service control entity resolves the notification signaling received by the awareness unit via a resolving unit, and obtains the supplementary service notification content. The supplementary service notification content includes at least a service type indicator or a connected user identifier.

In block S103: the VCC service control entity updates the call attribute of the user.

The resolving unit of the VCC service control entity notifies the recording unit to update the session handover capability of the user according to at least one of the service type indicator or the connected user identifier, and to update the call state of the user.

The method according to the embodiment of the invention will be described in detail via three examples below.

### Example 1

in an ECT service, the MSC notifies an opposite end of a call via a CPG (Call Progress) trunk signaling.

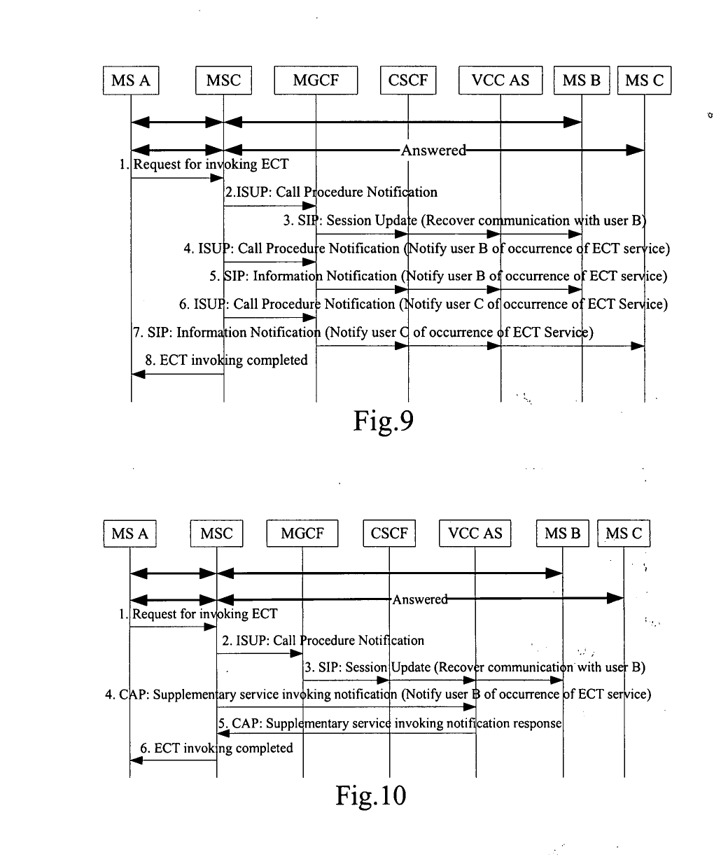

When a call between a user A of a Mobile Station (MS) A and a user B of a MS B is held, and the user A is in conversation with a user C of a MS C, the user A may initiate an ECT service. As shown in FIG. 9:

1, the user A sends a request for invoking the ECT service to an MSC;

2, the MSC sends a CPG signaling to the side of the user B indicating the user B to retrieve the call;

3, an MGCF converts the CPG signaling for retrieving the call into an UPDATE message of SIP signaling, indicating to modify the direction of media flow as bidirection, and sends the UPDATE message to the terminal of the user B through a CSCF, a VCC service control entity and the network of the user B;

4, the MSC sends to the user B a CPG signaling notifying the user B of the occurrence of the ECT service, together with the number of the user C;

5, the MGCF converts the CPG signaling notifying the occurrence of the ECT service into an INFO message (or a REFER, or a MESSAGE or the like) of SIP signaling, indicating that the service event is an ECT and carrying the number of user C. The MGCF sends the INFO message to the terminal of the user B through the CSCF, the VCC service control entity and the network of the user B. In this way, the user B may make awareness of the occurrence of the ECT service and that the user C is the new opposite end. When the INFO message passes through the VCC service control entity, the VCC service control entity detects the INFO message, and removes user A from the session (i.e., the session between user A and user C), that is, configures the session as irrelevant to user A;

6 the MSC also sends a CPG signaling to the user C notifying the occurrence of the ECT service and the number of the user B;

7, the MGCF converts the CPG signaling notifying the ECT service event and the number of the user B into an INFO message (or a REFER, or a MESSAGE or the like) of SIP signaling, and sends the INFO message to the terminal of the user C. In this way, the user C may make awareness of the occurrence of ECT service and that the user B is the new opposite end. When the INFO message passes through the VCC service control entity, the VCC service control entity detects the INFO message, and configures the session (the session between user A and user B) as irrelevant to user A. In this way, the call state of the user A becomes idle, and sessions related to the user A cannot be handed over.

8, the MSC connects the conversation between the user B and the user C, and releases the connection to the user A. This step may also be performed before step 4.

### Example 2

in an ECT service, the MSC notifies the VCC service control entity directly in an SS-CSI intelligent triggering mode.

When a call between the user A and the user B is held, and the user A and the user C are in conversation state, the user A may initiate the ECT service. As shown in FIG. 10:

1, the user A sends a request for invoking the ECT service to an MSC;

2, the MSC sends a CPG signaling to the side of the user B indicating the user B to retrieve the call;

3, an MGCF converts the CPG signaling for retrieving the call into an UPDATE message of SIP signaling, indicating to modify the direction of media flow as bidirection, and sends the UPDATE message to the terminal of the user B through a CSCF, a VCC service control entity and the network of the user B;

4, the MSC triggers the SS-CSI and sends an SS_INVOCATION_NOTIFY message to the VCC service control entity, indicating the occurrence of the ECT service;

5, the VCC service control entity returns a response message of the SS_INVOCATION_NOTIFY to the MSC after receiving the SS_INVOCATION_NOTIFY, and sets the call state of the user A as idle state, and configures both of the session between the user A and the user B and the session between the user A and the user C as irrelevant to user A. In this way, sessions related to the user A will not support handover;

6, the MSC connects the conversation between the user B and the user C, and releases the connection to the user A. This step may also be performed before step 4.

### Example 3

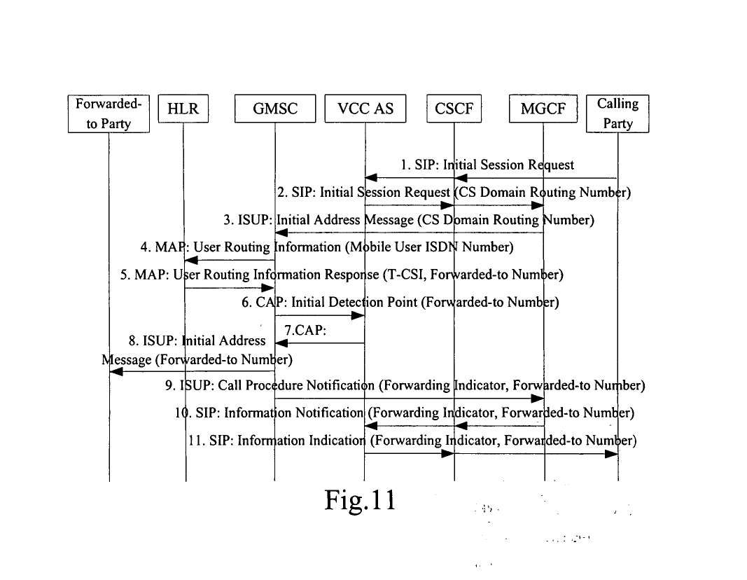

in a forwarding service, a GMSC notifies a calling party via a CPG trunk signaling. As shown in FIG. 11:

1, the home IMS domain of a called user receives an initial session request sent from the calling party;

2, when determining that a session is to be routed to the circuit domain according to a strategy, the VCC service control entity returns an initial session request carrying a CS domain routing number to a CSCF. The CSCF routes the session to the MGCF after receiving the initial session request;

3, the MGCF sends an initial address message to a GMSC of the home network of the called party according to the CS domain routing number so as to establish a CS domain session;

4, the GMSC retrieves the mobile user ISDN number of the called party after receiving the initial address message, and sends a user address information message to an HSS requesting information of user location;

5, when detecting that the called party has subscribed a forwarding service, such as a Call Forwarding Unconditional service, the HSS returns a forwarded-to number and T-CSI (CAMEL Subscriber Information of the called user);

6, the GMSC triggers a CAMEL service via the T-CSI, and sends an initial detection point message carrying a forwarding indicator and the forwarded-to number, to a Service Control Point (SCP);

7, the VCC service control entity returns a continue-calling indication;

8, the GMSC reroutes to the forwarded-to party according to the forwarded-to number;

9, the GMSC sends a CPG message carrying the forwarding indicator and the forwarded-to number, to the MGCF;

10, the MGCF converts the CPG message into an SIP message, and sends the SIP message back to the calling party along a session path of the initial session request. The SIP message may be an INFO, a REFER, a MESSAGE or the like, or may be a response message such as 181 (Call Being Forwarded);

11, when obtaining this SIP message in the session path, the VCC service control entity updates the call state of the user recorded as idle state, and marks the session as being unable to be handed over. Then, the VCC service control entity sends this SIP message back to the calling party along the session path.

In a forwarding service, the MSC may notify the VCC service control entity directly in an SS-CSI intelligent triggering mode. This process may be derived from the Example 2 and the Example 3.

### Example 4

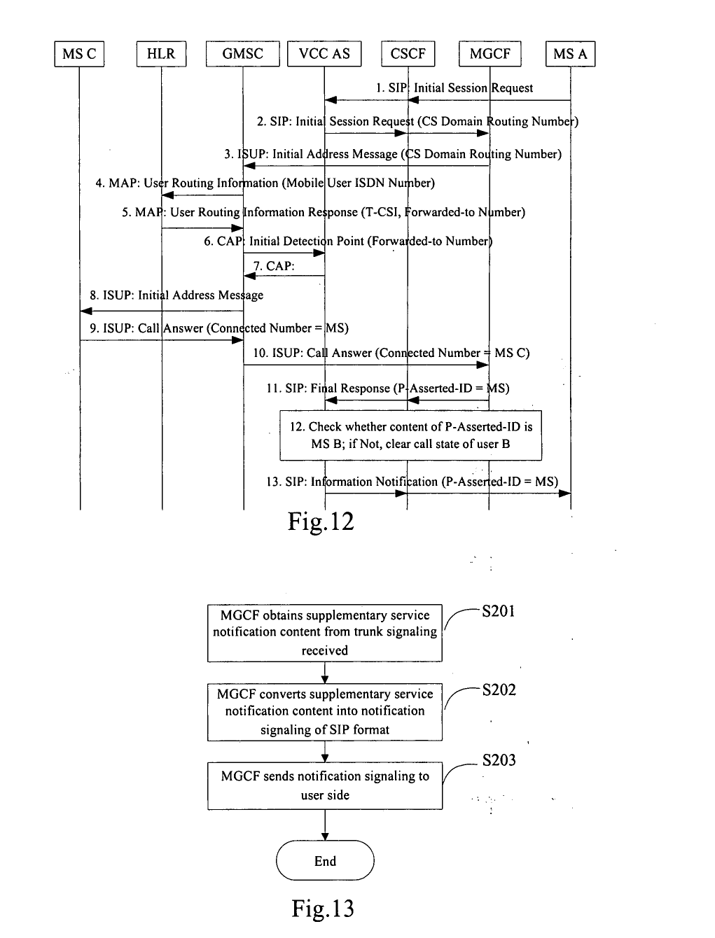

in a forwarding service, the VCC service control entity may determine whether a call is forwarded according to some parameters in a received SIP session indicating the identity of an actual called party. If the call has been forwarded, the VCC service control entity may modify the call state of user recorded. As shown in FIG. 12:

Step 1 to step 7 of this example are the same as those of the example 3 as shown in FIG. 11.

8, the GMSC reroutes to the forwarded-to party C, i.e., user C, according to the forwarded-to number;

9, the forwarded-to party C returns an answer message, the parameter Connected Number contained in the answer message indicates the user C is the actual called party;

10, the GMSC forwards the answer message to an MGCF;

11, the MGCF returns a session final response message 200 OK to the VCC service control entity, a parameter P-Asserted-ID contained in the 200 OK indicates that the user C is the actual called party;

12, the VCC service control entity determines whether the content of the parameter P-Asserted-ID contained in the 200 OK is the original called user B; if not, modifies the recorded call state of the user B;

13, the VCC service control entity returns an answer of the session response message 200 OK to the calling party.

As shown in FIG. 13, a process that a user side makes awareness of the occurrence of a supplementary service after the supplementary service is initiated by an IMS domain user, the call of which is anchored by the VCC service control entity, according to an embodiment of the invention, may include:

Block S201: an MGCF obtains supplementary service notification content from a trunk signaling received.

After the user initiates a supplementary service (the supplementary service includes, but is not limited to, an ECT service, a forwarding service, a call hold service or a call waiting service), an MSC (not limited to MSC) sends a trunk signaling containing the supplementary service notification content to an MGCF; the MGCF obtains the supplementary service notification content contained in the trunk signaling. The supplementary service notification content includes at least a supplementary service indicator.

Block S202: the MGCF converts the supplementary service notification content into a notification signaling of SIP format.

Block S203: the MGCF sends the notification signaling to user sides respectively.

If the supplementary service is an ECT service, the MGCF transparently transmits the notification signaling to both terminals of the new parties of the call directly. The notification signaling may or may not pass through the VCC service control entity according to the embodiments of the invention.

If the supplementary service is a forwarding service, the MGCF transparently transmits the notification signaling to the calling terminal directly. The notification signaling may or may not pass through the VCC service control entity according to the embodiments of the invention.

As can be seen from the above embodiments of the invention that, in the method according to the embodiments of the invention, an MGCF converts a trunk signaling into a notification signaling of SIP format and sends the notification signaling of SIP format to a VCC service control entity; or an MSC reports a notification signaling of CAP format directly to the VCC service control entity according to the subscription information of the user. With respect to the VCC service control entity according to the embodiments of the invention, this VCC service control entity is able to not only intercept a notification signaling of SIP format or CAP format, but also resolve supplementary service notification content from the notification signaling and update the call attribute of user stored in the VCC service control entity. Thus, the call attribute of user stored in the VCC service control entity may be kept synchronous with the actual call attribute of user, so that the VCC service control entity may make a correct decision according to the correct information.

The notification signaling of SIP format may also be forwarded to user sides, so that the related users may make awareness of the occurrence of a supplementary service.

Thus, with the method according to the embodiments of the invention, a user side may make awareness of the occurrence of a supplementary service. After converting a trunk signaling into a notification signaling of SIP format, the MGCF may send the notification signaling of SIP format to a user side directly.

The above described supplementary service performed by the user may be a circuit domain supplementary service.

Additional advantages and modifications may be readily recognized by a person of ordinary skill in the art. Therefore, the invention in its broader aspects is not limited to the specific details and representative embodiments shown and described herein. Accordingly, various modifications and variations may be made without departing from the spirit or scope of the invention as defined by the appended claims and their equivalents.

What is claimed is:

1. A method for making awareness of occurrence of a supplementary service, comprising:
obtaining a notification signaling notifying that a user performs a supplementary service by at least one of a Voice Call Continuity service control entity or an opposite end of a call; and
making awareness of occurrence of the supplementary service according to the notification signaling.

2. The method according to claim 1, wherein obtaining the notification signaling notifying that a user performs the supplementary service by the Voice Call Continuity service control entity comprises:
converting, by a Media Gateway Control Function, a trunk signaling containing supplementary service notification content received by the Media Gateway Control Function into a notification signaling of Session Initiation Protocol format after the user initiates the supplementary service; and
sending, by the Media Gateway Control Function, the notification signaling of Session Initiation Protocol format to the Voice Call Continuity service control entity.

3. The method according to claim 2, wherein
the supplementary service is an Explicit Call Transfer service, and the supplementary service notification content comprises a number of a new opposite end of the call;
the method further comprises:
forwarding, by the Voice Call Continuity service control entity, the notification signaling of Session Initiation Protocol format to terminals of new parties of the call; and
making awareness of occurrence of the Explicit Call Transfer service by the terminals of the new parties according to the notification signaling of Session Initiation Protocol format.

4. The method according to claim 2, wherein
the supplementary service is a forwarding service, the method further comprises:
forwarding, by the Voice Call Continuity service control entity, the notification signaling of Session Initiation Protocol format to a calling terminal; and
making awareness of occurrence of the forwarding service by the calling terminal according to the notification signaling of Session Initiation Protocol format.

5. The method according to claim 1, wherein the supplementary service is an Explicit Call Transfer service, or a call hold service or a call waiting service, and before the Voice Call Continuity service control entity receives the notification signaling, the method comprises:
reporting, by a Mobile Switching Center, a notification signaling containing the supplementary service notification content directly to the Voice Call Continuity service control entity according to subscription information of the user.

6. The method according to claim 1, further comprising:
updating, by the Voice Call Continuity service control entity, call attribute of the user according to content of the notification signaling.

7. The method according to claim 1, wherein the obtaining the notification signaling notifying that a user performs the supplementary service by the opposite end of a call comprises:
converting, by a Media Gateway Control Function, a trunk signaling containing supplementary service notification content received by the Media Gateway Control Function into a notification signaling of Session Initiation Protocol format; and
sending, by the Media Gateway Control Function, the notification signaling of Session Initiation Protocol format to user side of the opposite end of the call.

8. The method according to claim 7, wherein the supplementary service is an Explicit Call Transfer service, and the Media Gateway Control Function sends the notification signaling to terminals of new parties of the call.

9. The method according to claim 8, wherein the supplementary service notification content comprises a number of a new opposite end of the call, one of new parties of the call obtains a number of the other of the new parties according to the supplementary service notification content.

10. The method according to claim 7, wherein: the supplementary service is a forwarding service, and the Media Gateway Control Function sends the notification signaling to a calling terminal.

11. A Voice Call Continuity service control entity, comprising a recording unit for recording call attribute of a user,
an awareness unit, for identifying a notification signaling notifying that a user performs a supplementary service from signaling received by the Voice Call Continuity service control entity; and
a resolving unit, for resolving supplementary service notification content obtained from the notification signaling identified by the awareness unit and thereby triggering the recording unit to update the call attribute of the user.

12. The Voice Call Continuity service control entity according to claim 11, wherein the recording unit comprises at least one of
a first partition, for recording session handover capability of a user; or
a second partition, for recording call state of a user.

13. The Voice Call Continuity service control entity according to claim 12, wherein the supplementary service notification content resolved by the resolving unit comprises at least one of a service type indicator or a connected user identifier, the first partition performing at least one of updating the session handover capability recorded in the first partition according to the service type indicator, or making awareness of call forwarding information according to the connected user identifier and updating the session handover capability recorded in the first partition.

14. The Voice Call Continuity service control entity according to claim 13, wherein the first partition triggers the second partition to update the call state recorded in the second partition after the first partition updates the session handover capability of the user.

15. The Voice Call Continuity service control entity according to claim 12, wherein the supplementary service notification content resolved by the resolving unit comprises at least one of a service type indicator or a connected user identifier, the second partition updates the call state recorded in the second partition according to at least one of the service type indicator or the connected user identifier.

16. A media gateway control entity, comprising:
an obtaining unit, for obtaining supplementary service notification content from a received trunk signaling; and
a converting unit, for converting the supplementary service notification content obtained by the obtaining unit into a notification signaling of Session Initiation Protocol format notifying that a user performs a supplementary service, and sending the notification signaling of Session Initiation Protocol format to at least one of a user side or a Voice Call Continuity service control entity.

17. The media gateway control entity according to claim 16, wherein the obtaining unit further obtains a number of a new opposite end of a call from the trunk signaling if the supplementary service is an Explicit Call Transfer service; and the obtaining unit further obtains a forwarded-to number from the trunk signaling if the supplementary service is a forwarding service.
